(19) United States
(12) Patent Application Publication
(10) Pub. No.: US 2020/0241956 A1
(43) Pub. Date: Jul. 30, 2020

(54) MEMORY SYSTEM AND OPERATING METHOD THEREOF

(71) Applicant: SK hynix Inc., Gyeonggi-do (KR)

(72) Inventor: Ik Joon SON, Gyeonggi-do (KR)

(21) Appl. No.: 16/566,161

(22) Filed: Sep. 10, 2019

(30) Foreign Application Priority Data
Jan. 28, 2019 (KR) 10-2019-0010755

(51) Int. Cl. G06F 11/10; G06F 13/16; G06F 12/02; G06F 12/0882

(52) U.S. Cl. CPC G06F 11/102; G06F 11/1068; G06F 12/0882; G06F 12/0253; G06F 12/0246; G06F 13/1673

(57) ABSTRACT

A memory system and an operating method thereof are disclosed. A memory system includes a memory device configured to correct first data read from a first data storage region based on error correction data thereby generating second data and store the second data in a second data storage region; and a controller configured to generate the error correction data. The error correction data includes location information of an error bit of the first data.

### CROSS-REFERENCE TO RELATED APPLICATION

The present application claims priority under 35 U.S.C. § 119(a) to Korean application number 10-2019-0010755, filed on Jan. 28, 2019, which is incorporated herein by reference in its entirety.

### BACKGROUND

### 1. Technical Field

Various embodiments generally relate to a semiconductor device, and more particularly, to a memory system and an operating method thereof.

### 2. Related Art

In recent years, the paradigm for computer environments changed to ubiquitous computing in which computer systems may be used anytime and anywhere. As a result, use of portable electronic apparatuses such as mobile phones, digital cameras, and laptop computers has been increasing rapidly. Generally, portable electronic apparatuses use memory systems that employ memory devices. Memory systems may be used to store data used in the portable electronic apparatuses.

Memory systems using memory devices have no mechanical driving units, exhibit good stability and endurance, fast information access rate, and low power consumption. Such memory systems include a universal serial bus (USB) memory device, a memory card having various interfaces, a universal flash storage (UFS) device, a solid state drive (SSD), and the like.

### SUMMARY

Embodiments are directed to technology which efficiently copies data stored in a memory system.

In an embodiment of the present disclosure, a memory system may include: a memory device configured to correct first data read from a first data storage region based on error correction data thereby generating second data and store the second data in a second data storage region; and a controller configured to generate the error correction data. The error correction data includes location information of an error bit of the first data.

In an embodiment of the present disclosure, an operating method of a memory system may include: reading, by the memory device, first data from a first data storage region; temporarily storing, by the memory device, the first data; generating, by the controller, when an error bit is included in the first data, error correction data including location information of an error bit included in the temporarily stored first data; generating, by the memory device, second data by correcting the temporarily stored first data based on the error correction data; and storing, by the memory device, the second data in a second data storage region.

In an embodiment of the present disclosure, an operating method of a storage system includes a controller for controlling a storage device to perform an operation. The operating method comprising: detecting, by the controller, an error bit within data read from the storage device; providing, by the controller, the storage device with information representing a location of the error bit; and bit-flipping, by the storage device, the error bit according to the information.

According to an embodiment of the present disclosure, data stored in a memory system can be efficiently copied.

These and other features, aspects, and embodiments are described below in the section entitled “DETAILED DESCRIPTION”.

### BRIEF DESCRIPTION OF THE DRAWINGS

The above and other aspects, features and advantages of the present disclosure will be more clearly understood from the following detailed description taken in conjunction with the accompanying drawings, in which:

FIG. 1 is a diagram illustrating a configuration of a memory system according to an embodiment of the present disclosure;

FIG. 2 is a diagram describing a data storage region included in a nonvolatile memory device according to an embodiment of the present disclosure;

FIGS. 3 to 8 are diagrams describing an operation of a memory system according to an embodiment of the present disclosure;

FIG. 9 is a diagram illustrating a data processing system including a solid state drive (SSD) according to an embodiment of the present disclosure;

FIG. 10 is a diagram illustrating a data processing system including a memory system according to an embodiment of the present disclosure;

FIG. 11 is a diagram illustrating a data processing system including a memory system according to an embodiment of the present disclosure; and

FIG. 12 is a diagram illustrating a network system including a memory system according to an embodiment of the present disclosure.

### DETAILED DESCRIPTION

The foregoing and other features and advantages of the present disclosure are described more fully below with reference to the accompanying drawings in the context of various embodiments. The present invention may, however, be embodied in different forms and should not be construed as limited to the embodiments set forth herein. Rather, these embodiments are provided so that this disclosure is thorough, complete and fully conveys the scope of the present invention to one skilled in the art. Throughout the specification, reference to “an embodiment” or the like is not necessarily to only one embodiment, and different references to any such phrase are not necessarily to the same embodiment(s).

It will be understood that when an element or layer is referred to as being “on,” “connected to” or “coupled with” another element or layer, it can be directly on, connected or coupled with the other element or layer or one or more intervening elements or layers may be present. It will be further understood that the terms “comprises” and/or “comprising,” when used in this specification, do not preclude the presence or addition of other non-stated elements.

In the following description, like numbers refer to like elements throughout. Further, detailed description of well-known functions and configurations are omitted so as not obscure elements and features of the present invention.

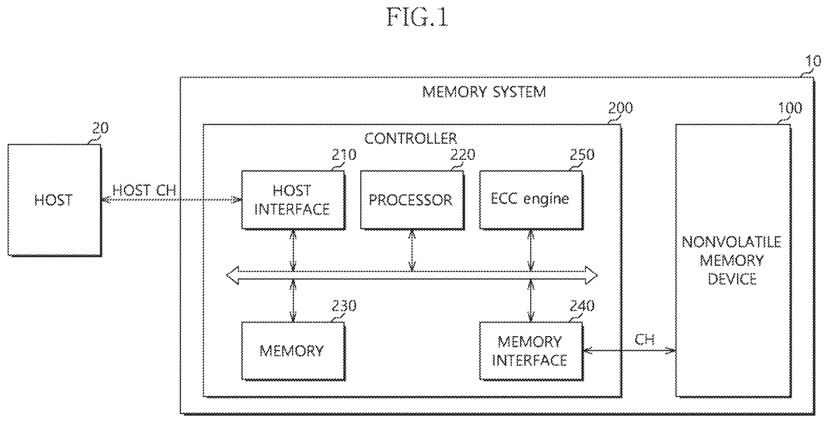

FIG. 1 is a diagram illustrating a configuration of a memory system according to an embodiment.

Referring to FIG. 1, a memory system 10 may store data to be accessed by a host 20, such as a mobile phone, an MP3 player, a laptop computer, a desktop computer, a game player, a television (TV), and/or an in-vehicle infotainment system.

The memory system 10 may be configured as any of various types of storage devices according to an interface protocol coupled to the host 20. For example, the memory system 10 may be configured as a solid state drive (SSD), a multimedia card in the form of MMC, eMMC, RS-MMC, and micro-MMC, a secure digital card in the form of SD, mini-SD, and micro-SD, a universal serial bus (USB) storage device, a universal flash storage (UFS) device, a personal computer memory card international association (PCMCIA) card type storage device, a peripheral component interconnection (PCI) card type storage device, a PCI-express (PCI-E) card type storage device, a compact flash (CF) card, a smart media card, and/or a memory stick.

The memory system 10 may be manufactured as any of various types of packages. For example, the memory system 10 may be manufactured as a package on package (POP), a system in package (SIP), a system on chip (SOC), a multi-chip package (MCP), a chip on board (COB), a wafer-level fabricated package (WFP), and/or a wafer-level stack package (WSP).

The memory system 10 may include a nonvolatile memory device 100 and a controller 200.

The nonvolatile memory device 100 may be operated as a storage medium of the memory system 10. The nonvolatile memory device 100 may include any of various types of nonvolatile memory devices according to a memory cell, such as a NAND flash memory device, a NOR flash memory device, a ferroelectric random access memory (FRAM) using a ferroelectric capacitor, a magnetic random access memory (MRAM) using a tunneling magneto-resistive (TMR) layer, a phase-change random access memory (PRAM) using a chalcogenide alloy, and/or a resistive random access memory (ReRAM) using a transition metal compound.

Although it is illustrated in FIG. 1 that the memory system 10 includes one nonvolatile memory device 100, such illustration is for clarity; the memory system 10 may include a plurality of nonvolatile memory devices and features and aspects of the present invention may be equally applied to the memory system 10 including the plurality of nonvolatile memory devices.

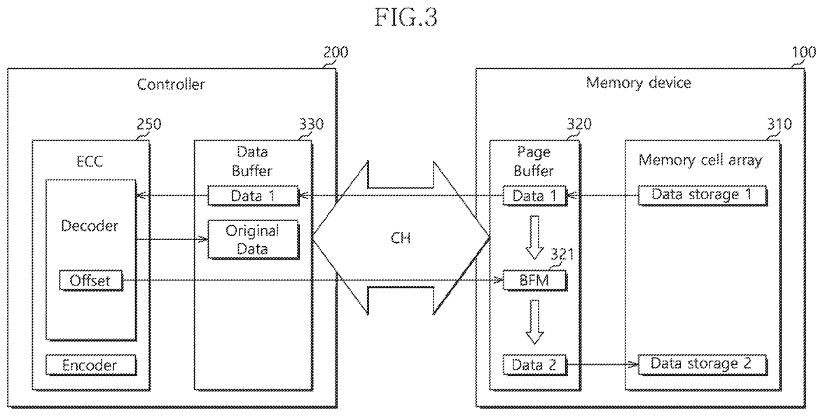

The nonvolatile memory device 100 may include a memory cell array (see 310 of FIG. 3) including a plurality of memory cells arranged at the intersections of word lines and bit lines. The memory cell array may include a plurality of memory blocks and each of the plurality of memory blocks may include a plurality of data pages.

For example, each of the memory cells in the memory cell array may be a single level cell (SLC) in which a single bit of data is to be stored or a multi level cell (MLC) in which two or more bits of data is to be stored. Thus, an MLC may be configured to store 2-bit data, 3-bit data, 4-bit data, or more bits of data. Sometimes, a memory cell in which 2-bit data is to be stored may be referred to as an MLC, a memory cell in which 3-bit data is to be stored may be referred to as a triple level cell (TLC), and a memory cell in which 4-bit data is to be stored may be referred to as a quadruple level cell (QLC). For simplicity, however, the term MLC may be used to denote any memory cell in which 2 or more bits of data are to be stored.

In an embodiment, a plurality of data pages may constitute one data page group. When the data page group is configured of a plurality of memory cells and each of the memory cells stores N-bit data, the data page group may include N data pages. For example, when each of the memory cells constituting the data page group is configured of a MLC in which 2-bit data is to be stored, the data page group may include a least significant bit (LSB) data page and a most significant bit (MSB) data page. When each of the memory cells constituting the data page group is configured of a TLC in which 3-bit data is to be stored, the data page group may include a least significant bit (LSB) data page, a center significant bit (CSB) data page, and a most significant bit (MSB) data page.

The memory cell array may include one or more memory cells of the SLC and the MLC. The memory cell array may include memory cells arranged in a two-dimensional (2D) horizontal structure or memory cells arranged in a 3D vertical structure.

The controller 200 may control overall operation of the memory system 10 through driving of firmware or software loaded into a memory 230. The controller 200 may decode and drive a code-type instruction or algorithm such as firmware or software. The controller 200 may be implemented with hardware or a combination of hardware and software.

The controller 200 may include a host interface 210, a processor 220, the memory 230, a memory interface 240, and an error correction code (ECC) engine 250.

The host interface 210 may perform interfacing between the host 20 and the memory system 10 according to a protocol of the host 20. For example, the host interface 210 may communicate with the host 20 through any of a SD protocol, a USB protocol, an MMC protocol, an eMMC protocol, a PCMCIA protocol, a parallel advanced technology attachment (PATA) protocol, a serial advanced technology attachment (SATA) protocol, a small computer system interface (SCSI) protocol, a serial attached SCSI (SAS) protocol, a PCI protocol, a PCI-E protocol, and a UFS protocol. The host interface 210 may perform a disk emulating function of supporting the host 20 to recognize an SSD as a general-purpose memory system, for example, a hard disk drive (HDD).

The processor 220 may be configured of a micro control unit (MCU) and/or a central processing unit (CPU). The processor 220 may process requests transmitted from the host 20. To process the requests transmitted from the host 20, the processor 220 may drive a code-type instruction or algorithm (for example, firmware) loaded into the memory 230 and control internal function blocks such as the host interface 210, the memory 230, the memory interface 240, and the ECC engine 250 and the nonvolatile memory device 100.

The processor 220 may generate control signals for controlling an operation of the nonvolatile memory device 100 based on the requests transmitted from the host 20 and provide the generated control signals to the nonvolatile memory device 100 through the memory interface 240. The processor 220 may analyze and process a signal input from the host 20. The processor 220 may control operations of the internal function blocks of the controller 200 according to firmware or software for driving the memory system 10.

The memory 230 may be configured of a random access memory (RAM) and may be arranged within or externally to the controller 200. The memory 230 may store the firmware driven through the processor 220. The memory 230 may also store data (for example, meta data) for driving the firmware. For example, the memory 230 may be operated as a working memory of the processor 220. The memory 230 may be configured to include a data buffer configured to temporarily store write data to be transmitted to the nonvolatile memory device 100 from the host 20 or read data to be transmitted to the host 20 from the nonvolatile memory device 100. For example, the memory 230 may be operated as a buffer memory of the processor 220.

The memory interface 240 may control the nonvolatile memory device 100 according to control of the processor 220. The memory interface 240 may refer to a memory controller. The memory interface 240 may provide control signals to the nonvolatile memory device 100. The control signals may include a command, an address, an operation control signal, and the like for controlling the nonvolatile memory device 100. The memory interface 240 may provide data stored in the data buffer to the nonvolatile memory device 100 or store data transmitted from the nonvolatile memory device 100 in the data buffer.

The ECC engine 250 may generate parity data by ECC encoding write data provided from the host 20. The nonvolatile memory device 100 may store the parity-added write data. The ECC engine 250 may generate parity-removed read data by ECC decoding read data read from the nonvolatile memory device 100 using the parity.

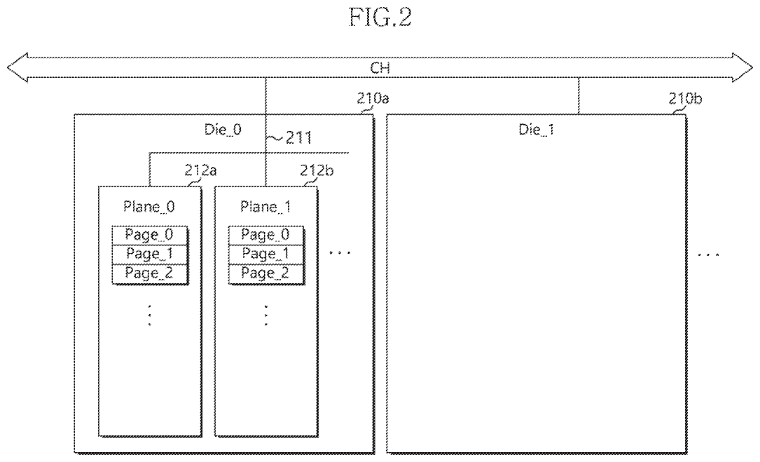

FIG. 2 is a diagram explaining a data storage region included in a nonvolatile memory device according to an embodiment.

Referring to FIG. 2, the nonvolatile memory device 100 may include a plurality of dies (Die_0 and Die_1) 210a and 210b which share a channel CH coupled to the controller 200. Each of the dies 210a and 210b may include a plurality of planes 212a and 212b which share a way 211 coupled to the channel CH and each of the planes 212a and 212b may include a plurality of data pages Page_0, Page_1, Page_2, . . . . Here, a data page may refer to a minimum unit of storage region for writing or reading data. Further, a plurality of data page units on which an erase operation is collectively performed may refer to a block and a plurality of blocks integrally managed may refer to a super block. Accordingly, the data storage region in the nonvolatile memory device 100 may refer to a die, a plane, a super block, a block, or a data page. However, as an example unless otherwise stated below, the data storage region may refer to a data page.

FIG. 3 is a diagram describing a data copy concept according to an embodiment.

Referring to FIG. 3, the memory system 10 may copy data stored in a first data storage region (Data storage 1) to a second data storage region (Data storage 2) which is independent of, and different from, the first data storage region.

For example, the nonvolatile memory device 100 may read data stored in the first data storage region and temporarily store the read data (first data (Data 1)) in a page buffer 320. The nonvolatile memory device 100 may transmit the first data stored in the page buffer 320 to the controller 200 through the channel CH.

The controller 200 may store the first data received from the nonvolatile memory device 100 through the channel CH in a data buffer 330.

The controller 200 may generate error correction data for the first data stored in the data buffer 330 using a decoder (Decoder) of the ECC engine 250. The controller 200 may transmit the generated error correction data (Offset) to the nonvolatile memory device 110. Here, the error correction data may include an offset or location of an error bit, and/or the number of error bits in the first data. The error bit may be occurred at least one of the process of storing the data in the first data storage region initially, the process of keeping the data stored in the first data storage region, and the process of reading the data stored in the first data storage region.

The controller 200 may transmit, to the nonvolatile memory device 100 through the channel CH, not all error-corrected first data but only the error correction data for the first data. The nonvolatile memory device 100 may generate second data (Data 2) by correcting the first data stored in the page buffer 320 based on the error correction data received from the controller 200.

For this, the nonvolatile memory device 100 may include a bit flip module (BFM) 321 configured to flip the error bit of the first data stored in the page buffer 320. The bit flip module 321 may correct the error bit included in the first data stored in the page buffer 320 based on the error correction data. For example, the bit flip module 321 may invert the error bit “0” to “1” when an error bit is “0” and the bit flip module 321 may invert the error bit “1” to “0” when an error bit is “1”. The nonvolatile memory device may store the generated second data in the second data storage region.

In an embodiment, the controller 200 may store the generated error correction data for the first data in the data buffer 330.

In an embodiment, the controller 200 may generate original data (Original Data) of the first data by performing an error correction operation on the first data. The controller 200 may store the generated original data of the first data in the data buffer 330.

In an embodiment, the controller 200 may generate the error correction data including an offset or location of an error bit, and/or the number of error bits in the first data by performing a syndrome operation on the first data based on a parity check matrix. The controller 200 may detect the error bit and the offset or the location thereof within the first data through the syndrome operation.

In an embodiment, the bit flip module 321 may be arranged in the outside of the page buffer 320 or the outside of the memory system 10.

For the memory system 10 to perform a data copy operation according to prior art, the nonvolatile memory device 100 may read the first data and transmit the first data to the controller 200 which may generate the second data by correcting the first data and transmit the second data to the nonvolatile memory device 100. In this case, time delay may occur due to exchange of a large amount of the second data between the controller 200 and the nonvolatile memory device 100.

However, the memory system 10 according to an embodiment may transmit to the nonvolatile memory device 100 not the second data but only the error correction data for correcting the error bit of the first data stored in the page buffer 320. Thus, an amount of data transmitted from the controller 200 to the nonvolatile memory device 100 and the time required for the data copy may be reduced.

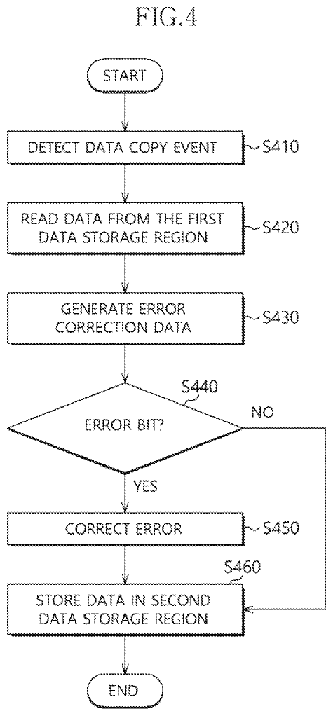

FIG. 4 is a flowchart describing an operating method of a memory system according to an embodiment.

Referring to FIG. 4, in operation S410, the controller 200 may detect a data copy event and start an operation for copying data stored in the first data storage region to the second data storage region when the data copy event is detected.

In an embodiment, the data copy event may refer to a situation in which data stored in one data storage region in the nonvolatile memory device 100 needs to be stored in another data storage region in the nonvolatile memory device 100, such as a garbage collection operation, a read reclaim operation, and the like.

In operation S420, when the data copy event is detected, the nonvolatile memory device 100 may read first data (Data 1) which is stored in the first data storage region (Data storage 1) and temporarily store the read first data in the page buffer 320. The nonvolatile memory device 100 may transmit the first data stored in the page buffer 320 to the controller 200 through the channel.

In operation S430, the controller 200 may receive the first data from the nonvolatile memory device 100 through the channel using the memory interface 240. The controller 200 may store the received first data in the data buffer 330. The controller 200 may generate error correction data for the first data stored in the data buffer 330 using the ECC engine 250. The controller 200 may transmit the error correction data to the nonvolatile memory device 100 through the channel CH using the memory interface 240.

In an embodiment, the controller 200 may store the generated error correction data in the data buffer 330.

In an embodiment, the ECC engine 250 may generate the error correction data by performing an ECC decoding operation including a syndrome operation on the first data based on a parity check matrix. This is because the result of performing the syndrome operation includes information representing location of an error, and/or the number of errors in the first data.

In operation S440, the nonvolatile memory device 100 may receive the error correction data from the controller 200 and determine whether or not an error bit is included in the first data stored in the page buffer 320 based on the received error correction data.

In operation S450, when the error bit is included in the first data stored in the page buffer 320, the nonvolatile memory device 100 may generate second data (Data 2) by correcting an error bit within the first data based on the location information of the error bit included in the error correction data.

In an embodiment, the nonvolatile memory device 100 may generate the second data using the bit flip module 321 configured to selectively invert or flip the error bit in the first data.

In operation S460, when the error bit is included in the first data stored in the page buffer 320, the nonvolatile memory device 100 may perform a write operation which stores the second data, which is the error-corrected first data, in the second data storage region (Data storage 2).

When the error bit is not included in the first data stored in the page buffer 320, the nonvolatile memory device 100 may not perform an error correction operation for generating the second data and may perform a write operation which stores the first data in the second data storage region.

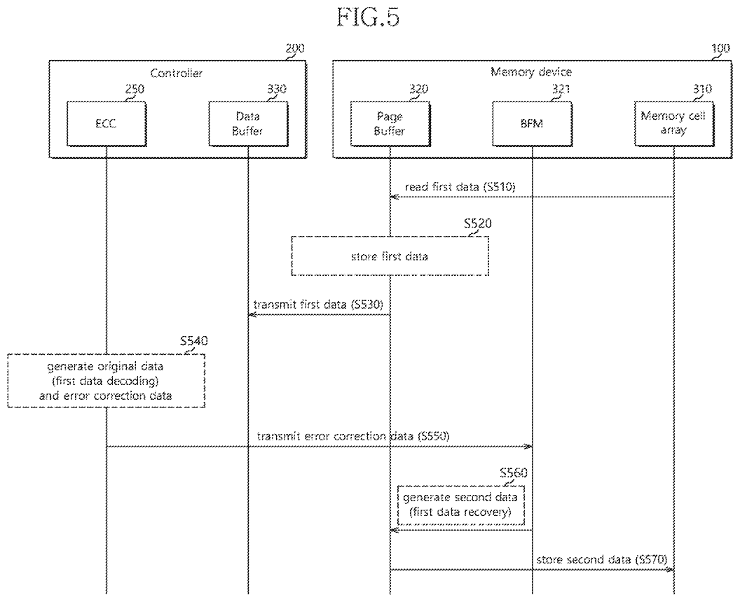

FIG. 5 is a sequence diagram describing an operation method of a memory system according to an embodiment.

Referring to FIG. 5, in operation S510, the nonvolatile memory device 100 may read the first data (Data 1) stored in the first data storage region (Data storage 1) of the memory cell array 310.

In operation S520, the nonvolatile memory device 100 may temporarily store the first data read from the first data storage region in the page buffer 320.

In operation S530, the nonvolatile memory device 100 may transmit the first data stored in the page buffer 320 to the controller 200 through the channel CH. The controller 200 may store the first data received through the channel CH in the data buffer 330.

In operation S540, the controller 200 may generate error correction data by performing a syndrome operation on the first data stored in the data buffer 330 based on a parity check matrix through the ECC engine 250. Further, the controller 200 may generate original data (Original Data) of the first data by performing error correction operation on the first data.

In operation S550, the controller 200 may transmit the error correction data to the bit flip module 321.

In an embodiment, the controller 200 may store the error correction data in the data buffer 330 and transmit the error correction data stored in the data buffer 330 to the bit flip module 321 of the nonvolatile memory device 100.

In operation S560, the bit flip module 321 may generate second data (Data 2) by correcting an error bit of the first data stored in the page buffer 320 based on the error correction data. For example, the bit flip module 321 may recover the original data of the first data. That is, the second data is the error-corrected first data or the original data.

In an embodiment, the bit flip module 321 may correct the error in the first data by selectively inverting the error bit.

In an embodiment, the bit flip module 321 may not generate the second data when the error bit is not included in the first data.

In operation S570, the page buffer 320 may store the second data in the second data storage region (Data storage 2).

In an embodiment, the page buffer 320 may store the first data in the second data storage region when the error bit is not included in the first data.

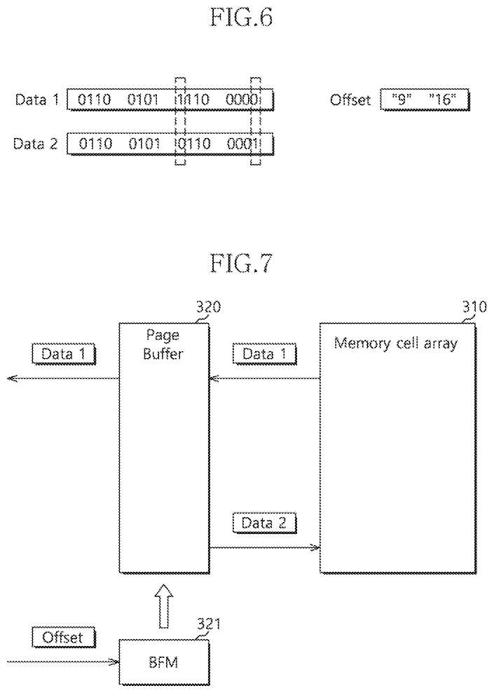

FIG. 6 is a diagram illustrating error correction data according to an embodiment.

Referring to FIG. 6, the first data may refer to data in which an error occurs in a process of storing data in the first data storage region, after such process, or in a process of reading data stored in the first data storage region. The second data may refer to the error-corrected first data. Accordingly, in the example of FIG. 6, the error correction data (Offset) for correcting an error bit included in the first data refers to offset or location information indicating a ninth bit and a twelfth bit among 12 bits constituting the first data. Based on the error correction data, the memory system 10 may generate the second data by performing an error correction operation of inverting the ninth bit and the twelfth bit among the 12 bits constituting the first data stored in the page buffer 320 and store the generated second data in the second data storage region.

FIG. 7 is a diagram illustrating another example of the nonvolatile memory device illustrated in FIG. 3.

Referring to FIG. 7, the bit flip module (BFM) 321 may be provided externally to the page buffer 320. The bit flip module 321 may receive offset information as the error correction data (Offset) and generate the second data (Data 2) by correcting the first data (Data 1) stored in the page buffer 320 based on the received error correction data.

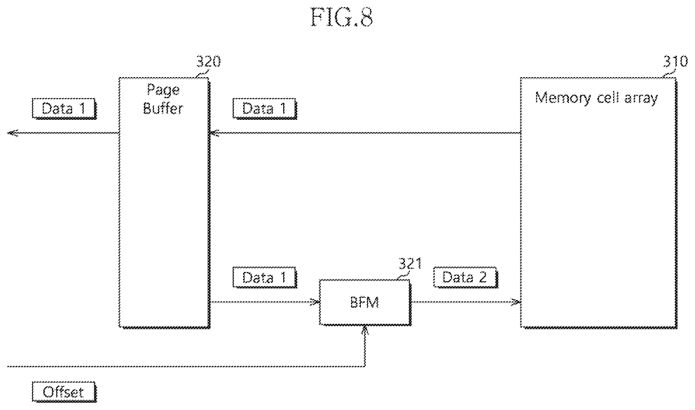

FIG. 8 is a diagram illustrating another example of the nonvolatile memory device illustrated in FIG. 3.

Referring to FIG. 8, the bit flip module (BFM) 321 may be provided between the page buffer 320 and the memory cell array 310. The bit flip module 321 may receive the offset information as the error correction data (Offset). The bit flip module 321 may receive the first data (Data 1) from the page buffer 320. The bit flip module 321 may generate the second data (Data 2) by correcting the first data based on the error correction data. The page buffer 320 may store the generated second data in the memory cell array 310.

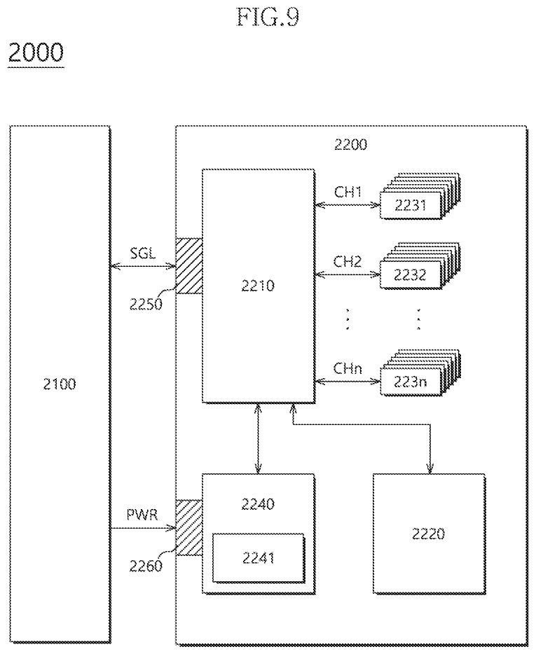

FIG. 9 is a block diagram illustrating a data processing system including a solid state drive (SSD) according to an embodiment. Referring to FIG. 9, a data processing system 2000 may include a host 2100 and a solid state drive (SSD) 2200.

The SSD 2200 may include a controller 2210, a buffer memory device 2220, nonvolatile memory devices 2231 to 223n, a power supply 2240, a signal connector 2250, and a power connector 2260.

The controller 2210 may control overall operation of the SSD 2200.

The buffer memory device 2220 may temporarily store data which are to be stored in the nonvolatile memory devices 2231 to 223n. Further, the buffer memory device 2220 may temporarily store data which are read out from the nonvolatile memory devices 2231 to 223n. The data temporarily stored in the buffer memory device 2220 may be transmitted to the host 2100 or the nonvolatile memory devices 2231 to 223n according to control of the controller 2210.

The nonvolatile memory devices 2231 to 223n may be used as storage media of the SSD 2200. The nonvolatile memory devices 2231 to 223n may be coupled with the controller 2210 through a plurality of channels CH1 to CHn, respectively. One or more nonvolatile memory devices may be coupled to one channel. The nonvolatile memory devices coupled to one channel may be coupled to the same signal bus and data bus.

The power supply 2240 may provide power PWR inputted through the power connector 2260 to the inside of the SSD 2200. The power supply 2240 may include an auxiliary power supply 2241. The auxiliary power supply 2241 may supply power in order for the SSD 2200 to be properly terminated when sudden power-off (SPO) occurs. The auxiliary power supply 2241 may include large capacity capacitors capable of charging the power PWR.

The controller 2210 may exchange a signal SGL with the host 2100 through the signal connector 2250. The signal SGL may include a command, an address, data, and the like. The signal connector 2250 may be configured as any of various types of connectors according to an interface scheme between the host 2100 and the SSD 2200.

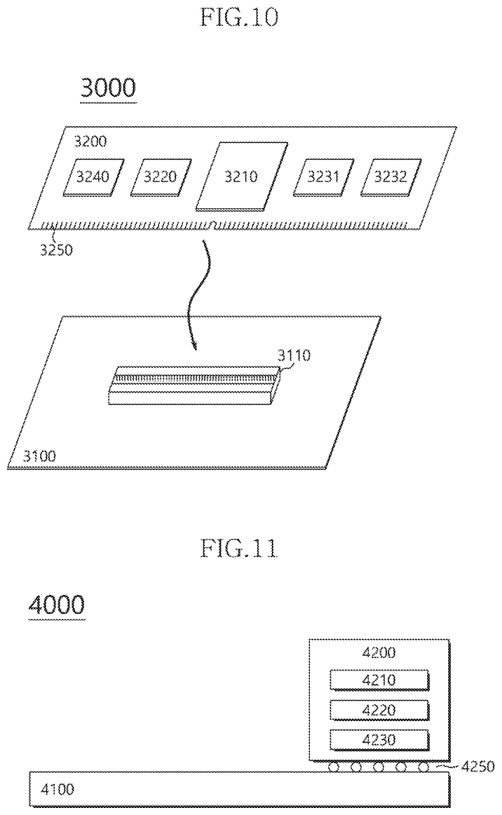

FIG. 10 is a diagram illustrating a data processing system including a memory system according to an embodiment. Referring to FIG. 10, a data processing system 3000 may include a host 3100 and a memory system 3200.

The host 3100 may be configured in the form of a board such as a printed circuit board. Although not shown in FIG. 10, the host 3100 may include internal function blocks for performing functions of the host.

The host 3100 may include a connection terminal 3110 such as a socket, a slot or a connector. The memory system 3200 may be mounted on the connection terminal 3110.

The memory system 3200 may be configured in the form of a board such as a printed circuit board. The memory system 3200 may refer to a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control overall operation of the memory system 3200. The controller 3210 may be configured in the same manner as the controller 2210 shown in FIG. 9.

The buffer memory device 3220 may temporarily store data to be stored in the nonvolatile memory devices 3231 and 3232. Further, the buffer memory device 3220 may temporarily store data read out from the nonvolatile memory devices 3231 and 3232. The data temporarily stored in the buffer memory device 3220 may be transmitted to the host 3100 or the nonvolatile memory devices 3231 and 3232 according to control of the controller 3210.

The nonvolatile memory devices 3231 and 3232 may be used as storage media of the memory system 3200.

The PMIC 3240 may provide power inputted through the connection terminal 3250, to the inside of the memory system 3200. The PMIC 3240 may manage the power of the memory system 3200 according to control of the controller 3210.

The connection terminal 3250 may be coupled to the connection terminal 3110 of the host 3100. Through the connection terminal 3250, signals such as commands, addresses, data and the like, and power may be transferred between the host 3100 and the memory system 3200. The connection terminal 3250 may be configured as any of various types according to an interface scheme between the host 3100 and the memory system 3200. The connection terminal 3250 may be disposed on any one side of the memory system 3200.

FIG. 11 is a block diagram illustrating a data processing system including a memory system according to an embodiment. Referring to FIG. 11, a data processing system 4000 may include a host 4100 and a memory system 4200.

The host 4100 may be configured in the form of a board such as a printed circuit board. Although not shown in FIG. 11, the host 4100 may include internal function blocks for performing functions of the host.

The memory system 4200 may be configured in the form of a surface-mounting type package. The memory system 4200 may be mounted on the host 4100 through solder balls 4250. The memory system 4200 may include a controller 4210, a buffer memory device 4220, and a nonvolatile memory device 4230.

The controller 4210 may control overall operation of the memory system 4200. The controller 4210 may be configured in the same manner as the controller 2210 shown in FIG. 9.

The buffer memory device 4220 may temporarily store data to be stored in the nonvolatile memory device 4230. Further, the buffer memory device 4220 may temporarily store data read out from the nonvolatile memory device 4230. The data temporarily stored in the buffer memory device 4220 may be transmitted to the host 4100 or the nonvolatile memory device 4230 according to control of the controller 4210.

The nonvolatile memory device 4230 may be used as a storage medium of the memory system 4200.

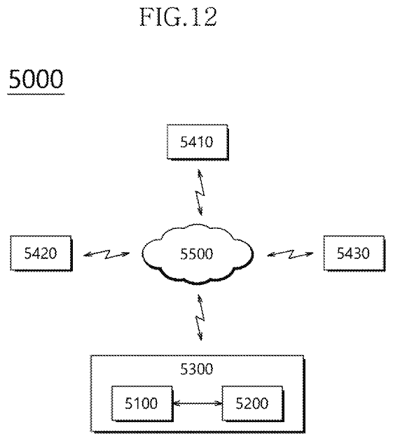

FIG. 12 is a diagram illustrating a network system 5000 including a memory system according to an embodiment. Referring to FIG. 12, the network system 5000 may include a server system 5300 and a plurality of client systems 5410 to 5430 which are coupled to each other through a network 5500.

The server system 5300 may service data in response to requests from the plurality of client systems 5410 to 5430. For example, the server system 5300 may store data provided from the plurality of client systems 5410 to 5430. In another example, the server system 5300 may provide data to the plurality of client systems 5410 to 5430.

The server system 5300 may include a host 5100 and a memory system 5200. The memory system 5200 may be configured as the memory system 10 illustrated in FIG. 1, the memory system 2200 illustrated in FIG. 9, the memory system 3200 illustrated in FIG. 10, or the memory system 4200 illustrated in FIG. 11.

The above described embodiments of the present invention are intended to illustrate and not to limit the present invention. Various alternatives and equivalents are possible. The invention is not limited by the embodiments described herein. Nor is the invention limited to any specific type of semiconductor device. Other additions, subtractions, or modifications of the present disclosure are encompassed by the invention to the extent they fall within the scope of the appended claims.

What is claimed is:

1. A memory system comprising:
a memory device configured to correct first data read from a first data storage region based on error correction data thereby generating second data and store the second data in a second data storage region; and
a controller configured to generate the error correction data,
wherein the error correction data includes location information of an error bit of the first data.

2. The memory system of claim 1, wherein the memory device includes:
a page buffer configured to store the first data read from the first data storage region; and
a bit flip module configured to generate the second data by inverting at least one error bit included in the first data stored in the page buffer based on the error correction data.

3. The memory system of claim 1, wherein the controller includes:
a memory configured to store the first data received from the memory device; and
an error correction code (ECC) engine configured to generate the error correction data by performing an ECC decoding operation on the first data stored in the memory.

4. The memory system of claim 1,
wherein the controller further detects a data copy event in which the first data stored in the first data storage region is to be copied to the second data storage region, and
wherein the controller generates the error correction data when the data copy event is detected.

5. The memory system of claim 4, wherein the data copy event is one of a garbage correction operation and a read reclaim operation.

6. The memory system of claim 1, wherein the controller further includes a memory interface configured to receive the first data from the memory device and transmit the error correction data to the memory device.

7. The memory system of claim 1, wherein the memory device stores the first data read from the first data storage region in the second data storage region when the error bit is not included in the first data.

8. An operating method of a memory system which includes a memory device and a controller configured to control the memory device, the method comprising:
reading, by the memory device, first data from a first data storage region;
temporarily storing, by the memory device, the first data;
generating, by the controller, when an error bit is included in the first data, error correction data including location information of an error bit included in the temporarily stored first data;
generating, by the memory device, second data by correcting the temporarily stored first data based on the error correction data; and
storing, by the memory device, the second data in a second data storage region.

9. The memory system of claim 8, wherein the temporarily storing includes storing the first data read from the first data storage region in a page buffer included in the memory device.

10. The memory system of claim 8, wherein the temporarily stored first data is corrected by inverting at least one error bit included in the temporarily stored first data based on the error correction data.

11. The memory system of claim 8,
further comprising transmitting, by the memory device, the temporarily stored first data to the controller,
wherein the generating of the error correction data includes performing an error correction code (ECC) decoding operation on the temporarily stored first data.

12. The memory system of claim 8,
further comprising detecting a data copy event in which the first data stored in the first storage region is to be copied to the second data storage region,
wherein the reading of the first data from the first data storage region is performed when the data copy event is detected.

13. The memory system of claim 12, wherein the data copy event is one of a garbage collection operation and a read reclaim operation.

14. The memory system of claim 8,
further comprising:
receiving, by the controller, the temporarily stored first data from the memory device; and
receiving, by the memory device, the error correction data from the controller,
wherein the generating of the error correction data includes performing an error correction code (ECC) decoding operation on the first data received from the memory device, and
wherein the temporarily stored first data is corrected by inverting at least one error bit included in the temporarily stored first data based on the error correction data.

15. The memory system of claim 8, wherein the storing of the second data in the second data storage region includes storing the temporarily stored first data in the second data storage region when the error bit is not included in the first data.

16. An operating method of a storage system including a controller for controlling a storage device to perform an operation, the operating method comprising:
detecting, by the controller, an error bit within data read from the storage device;
providing, by the controller, the storage device with information representing a location of the error bit; and
bit-flipping, by the storage device, the error bit according to the information.
